(19) United States
(12) Patent Application Publication
(10) Pub. No.: US 2017/0034991 A1
(43) Pub. Date: Feb. 9, 2017

(54) Delivery Mechanism for Vegetation Growth

(71) Applicant: Anew Green, Inc., Longmont, CO (US)

(72) Inventors: Dennis Estabrooks, Longmont, CO (US); Eric Jepsen, Longmont, CO (US)

(21) Appl. No.: 15/303,190

(22) PCT Filed: Mar. 20, 2015
(86) PCT No.: PCT/US2015/021706

§ 371 Date: Oct. 10, 2016

Related U.S. Application Data
(60) Provisional application No. 61/978,745, filed on Apr. 11, 2014.

(51) Int. Cl. A01C 1/04

(52) U.S. Cl. CPC A01C 1/046

(57) ABSTRACT

Disclosed is a capsule or other self-contained packets containing bioenvironmental seed delivery units for vegetation plantings. Each packet has a water soluble outer shell that contains seeds, fertilizer, char, topsoil, mulch, 5 compost, or other landscaping/agriculture additives or enhancers in any combination. These packets are self-contained units that is easily transported and distributed on any type of terrain.

### BACKGROUND

There are many landscape environments that have either been altered by human and/or natural events to make the environment difficult for vegetation to grow on. For example, in many types of mining all of the topsoil is removed all to reach the mineral deposits to be extracted. After the mine has extracted all of mineral, the remaining landscape has no vegetation and has been stripped of all soil needed to ensure future vegetation growth at desired levels of ground cover.

Often, when a mine stops extracting the desired minerals, there is generally a barren landscape with no near term possibility of re-vegetation and/or incomplete re-vegetation. If a company, community or government chooses to re-vegetate a piece land it often has to deliver vast amounts soil rich with nutrients and seed to start the re-vegetation process.

Other times when re-vegetation is needed and/or desired include when road or other construction projects are completed. With many road projects the sides of the roadways often need to be re-vegetated because the earth moving equipment removed most soil and vegetation and/or the traffic of the construction vehicles has removed all the vegetation. Currently, equipment is often brought to the site to spray fertilizer and seed on top of the ground. If there is no soil to begin with, then an application of seed and fertilizer might work for the short term (months), but it eventually dies off since the landscape has little to no components for long term success.

Another instance that re-vegetation is often desirable is after a wild land fire. Re-vegetation efforts after a forest fire can be extremely costly and difficult to achieve. Many forest fires are located in difficult to reach places and/or terrain so any type of re-vegetation effort after the fire is put out is difficult at best. Generally, there is a high desire to re-vegetate a burn area as fast as possible since if a large rain event occurs shortly after the fire, the resulting erosion can remove large amounts of soil and makes the recovery process of the land even longer in addition to causing issues downstream of the fire area with flooding.

Various methods of re-vegetation are known in the art. Currently in agricultural type re-vegetation efforts, seeds are applied to a land surface. This application usually requires three steps:

Step 1: The land to be seeded is first pretreated between 6-12 inches below the surface with fertilizers, new soil, lime, char or other soil enhancers that are manually tilled into the ground surface using heavy equipment. All the land to be seeded is pretreated, even portions of the land between where seeds are to be applied. This is a time consuming and expensive operation that requires machinery such as tractors.

Step 2: Seeds are applied by drilling down to a depth of 6-12 inches to this prepared ground.

Step 3: Then usually hay or other moisture retention material is laid on top of the treated land. All the land is post treated even between where seeds are applied. This is an expensive and time consuming operation that requires heavy machinery.

Another known method is to spray a mixture of seed and some sort of moisture retention material on to the area to be re-vegetated by creating a surly of seeds, moisture retention material and water, sometimes with a binder mixed in as well to hold the material together.

The foregoing example of the related art and limitations related therewith are intended to be illustrative and not exclusive. Other limitations of the related art will become apparent to those of skill in the art upon a reading of the specification and a study of the drawings.

### SUMMARY

One aspect of the present disclosure is a capsule or other self-contained packets containing bioenvironmental seed delivery units for vegetation plantings. Each packet has a water soluble outer shell that contains seeds, fertilizer, char, topsoil, mulch, compost, or other landscaping/agriculture additives or enhancers in any combination. These packets are self-contained units that is easily transported and distributed on any type of terrain.

One aspect of the present disclosure is to reduce and or completely eliminate the step of delivering nutrient rich soil before re-vegetation can start.

One aspect of the present disclosure is to address the issues of re-vegetation on soils that are currently completely devoid of vegetation.

One aspect of the present disclosure is to eliminate the need to apply soil to an area to be re-vegetated as the mini environments can initiate growth in the short term and create a sustainable mini environment in the long term without large scale soil replacement.

One aspect of the present disclosure is that barren landscapes remain hostile to weed growth since the areas where the packets are placed are the only areas where growth can occur initially. The areas between packets remain hostile to weed growth thereby dramatically reducing post treatment of vegetative lands with weed control materials.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

In addition to the exemplary aspects and embodiments described above, further aspects and embodiments will become apparent by reference to the accompanying drawings forming a part of this specification wherein like reference characters designate corresponding parts in the several views.

The present disclosure is directed to transportable mini self-sustaining environments that can be applied to areas where vegetation is desired. Small material delivery devices have an outer shell of water soluble material enclosing a variety of materials. The material inside include but are not limited to: wood char, fertilizer, seed, dirt, compost, hay, and similar materials. These packets can be delivered to any areas where re-vegetation desired, including areas that are completely void of vegetation and/or topsoil.

### BRIEF DESCRIPTION OF THE DRAWINGS

FIG. 1 is a schematic view of material delivery devices being formed.

FIG. 2 shows the various steps of the process.

FIGS. 3a-c shows various possible land type.

FIG. 4 is a schematic view showing the formation of the packet.

FIG. 5 is a perspective view of a sheet containing multiple packets.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

The present disclosure is directed to transportable mini self-sustaining environments that can be applied to areas where vegetation is desired. Small material delivery devices 100 have an outer shell 101 of water soluble material enclosing a variety of materials. The material inside include but are not limited to: wood char 104, fertilizer 105, seed 106, compost 107, nutrients 108, hay, dirt, and similar materials. These packets 100 can be delivered to any areas where re-vegetation desired, including areas that are completely void of vegetation and/or topsoil.

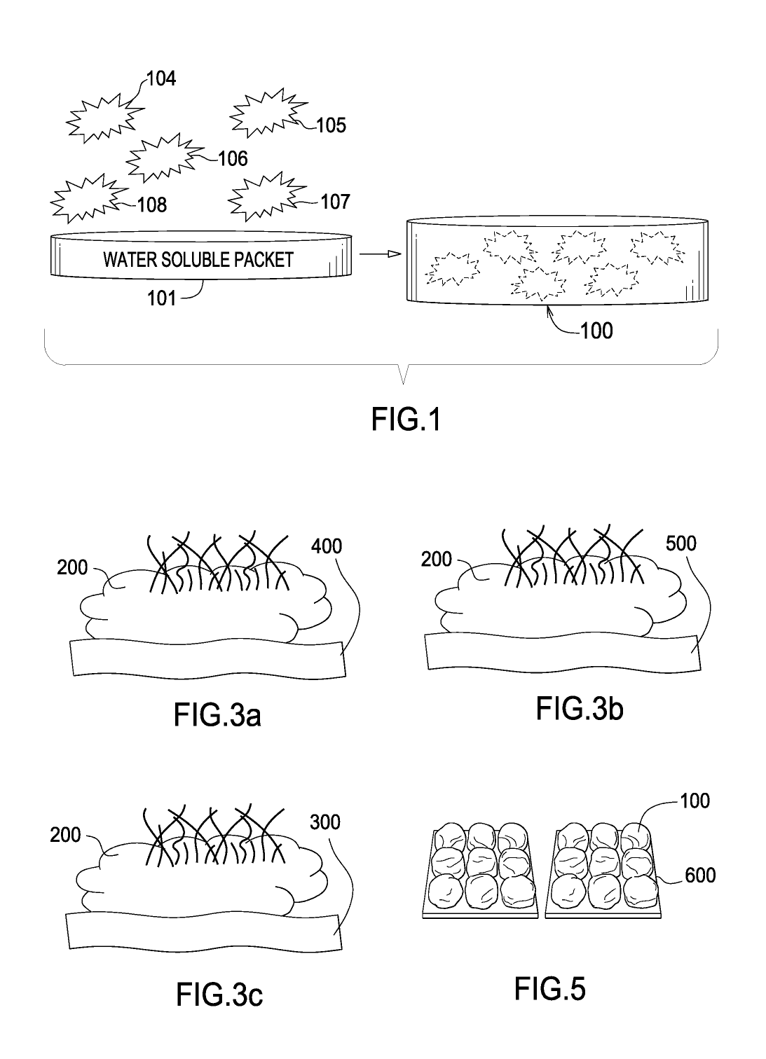

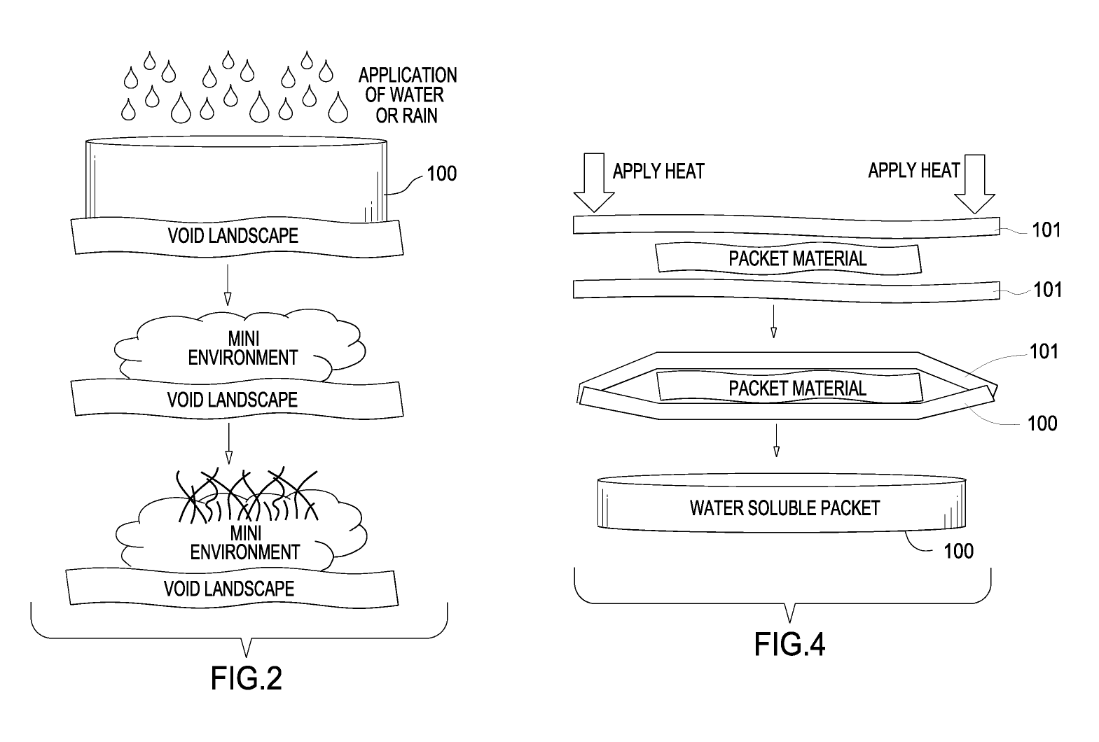

Referring first to FIG. 1, a material delivery device 100 is created to contain the needed material to create a micro-environment to support plant growth. The material delivery device 100 has a water soluble outer shell 101. The outer shell 101 can be constructed from Polyvinyl Alcohol (PVA), gelatin, vegetable based hydroxypropyl methyl cellulose (HPMC), or other water soluble materials. Poly vinyl based films, like PVA, are the preferred outer shell material due to an number of factors, including its ease of manufacture, flexibility, non-toxicity, biodegradability, heat stability, excellent barrier protection, availability of edible grades, high strength and a wide variety of cold/warm/hot water soluble grades. The water soluble outer shell 101 protects the internal contents from the outside environment until exposure is desired. The material delivery device 100 is not activated until water is applied to the outer shell 101, for example from rain or sprinklers. The temperature of the water and the time the water is in contact with the outer shell 101 are factors in the time it takes for the outer shell 101 to dissolve. The shell's thickness and its composition can be designed by those skilled in art of making PVA films to control the time of contact with water and/or temperature of water it takes to dissolve the outer shell. For example the outer shell 101 can be designed such that it will not dissolve until the water in contact with it is above 60 degrees F. for chosen amount of time so the packets can be applied on top of snow and will only dissolve when the snow melts. This enables the packets 100 to be distributed on terrain in winter and the contents will remain protected from the elements until water reaches 60 degrees F.

When water dissolves the packet's outer shell 101, the material inside is released and the water is absorbed by compressed mulch, compost, char, hay, etc. contained in the packet 100. These materials can absorb water and expand significantly in volume in the process. The char and/or other expanded material create a mini-environment 200 for the seeds to germinate in. First the expanded material acts as both the soil for the seed(s) to germinate in and simultaneously acts as cover for the seeds to reduce the chances the seed is blown and/or washed away or eaten. Any char, lime, fertilizer or other additives contained within said packet help also retain water for the seeds while also providing chemicals in the surrounding soils and providing necessary nutrients for seeds to germinate in the applied environment. This mini-environment 200 allows the seeds to germinate and gives the newly sprouted plant a chance to put down roots through the material into the ground to be re-vegetated. Many small micro-environments in a given area allow the plant to germinate and root into the soil, stabilizing the soil and starting re-vegetation process.

The material delivery devices 100 described above can be applied individually to an area to be re-vegetated, that is in packets that are not attached to one another, or can be applied in sheets or rolls where packets are attached to one another by a film 600 as seen in FIG. 5. In the depicted embodiment the material delivery devices 100 are approximately 2 inches by 2 inches in size and generally round or oval in shape. The shape of the exterior of the material delivery devices 100 can be varied according to the needs of a given environment. For example, if the material delivery devices 100 are going to be spread in areas with steep hillsides, it may be desirable to from them in a shaped closer to a square that would reduce the amount the material delivery devices 100 roll after being dropped.

This material delivery device 100 allows the creation of mini environments 200 capable of initiating and sustaining vegetation growth without the need of large amounts of soil. FIGS. 3a-c depict various land types that the mini environments 200 allow seeds to grow on. FIG. 3a shows void landscape 400 created by mining. FIG. 3b shows a burned landscape 500. FIG. 3c shows a tough grow area created by other forces such as erosion. The material delivery device 100 is delivered to the top of the landscape area and as soon as water is present at the appropriate temperature and duration, by either manually or naturally, the film 101 is dissolved releasing the contents onto the ground. The combination of materials creates a mini environment 200 on the ground that is very suited to plant growth, thereby starting the vegetation process. Overtime the mini environments 200 start and maintain their own lifecycle and thus begin to contribute their own organic material to the landscape. The mini environments 200 are key to creating and sustaining soil over the vegetative life cycle.

An important ingredient of one embodiment of the material delivery devices 100 is Biochar. BioChar is an organic, carbon rich, material such as wood, which has been heated to high temperatures in the absence of oxygen. This process is called pyrolysis and creates a material that looks similar to coal. Although it may look like coal its composition is different and beneficial in soil re-vegetation. BioChar has great characteristics that make it very important component within the material delivery devices 100 in most applications. BioChar has the ability to retain large amounts of water, sequester toxic minerals and hold valuable nutrients over long periods of time. These characteristics can be very important since many current fertilizers and other topical vegetative applications lose their effectiveness within months.

The present disclosure aims to solve the forest re-vegetation effort by delivering mini, self-sustaining environments that can activated by natural weather (any type of moisture). Current post fire re-vegetation efforts have a success rate of less than 10% since the burned landscape does not support the vegetative life cycle. The invention seeks to dramatically improve this success rate of post fire and other re-vegetation efforts.

FIG. 4 is a schematic view of the forming of the packets from the films. Material delivery devices 100 are made using one or more films chosen to have the desired dissolving temperature and time requirement and heat sealing open ends. Typically two films are used with packet shape being rectangular and all four sides heat sealed. Though a packet could be any shape, rectangular square, round, etc.

A packet can be generally comprised of the following items: 50-90% soil, 0-40% compost, 0-40% BioChar, 0-10% seed, 0-10% fertilizer, 0-10% Red Mud, 0-10% other material suitable to providing additional water retention and or growth enhancers such as nitrogen, phosphorus, potassium and iron. The percentages are based on volume and can be made to a generic mixture that can be applied in multiple areas regardless of soil type and condition to provide substantial increase in growth initiation and longevity.

The packets can also be specifically customized to match a specific soil type or condition. For example, if a particular soil is high in PH level the char, compost and fertilizer ratio can be adjusted to provide the best opportunity for growth for a particular soil. The packets can also be customized to suit a particular regions governmental regulation. For example, the state of Utah may require that the char used to reclaim soil come only from char derived from local tree clearing operations. In this case the packets can be specifically customized not only for the soil type but also for the source of the char materials. The seed mix is also customized to particular regions in order to provide seeds that match the existing native landscape vegetation.

Water-soluble films, like PVA, and their use in forming water-soluble products are well known in the art. The prior art of water soluble films demonstrates various uses for such films. Water soluble films have been used to enclose materials like soaps. U.S. Pat. No. 6,946,501 discloses soluble containers into which laundry detergents can be placed.

Although means for forming films for various applications are known in the art, there is a need for a water soluble film packet that contains all the needs for vegetation growth upon exposure to sufficient moisture and sunlight.

Tests with using the material delivery device 100 have been successful in growing vegetation on many kinds of contaminated dirt and even sand. Some of the possible applications for the material delivery devices 100 include reclaiming forest fire and mining lands, planting vegetable gardens, starting or over seeding grass lawns, tree plantings, flower gardens, vegetation pots, farm land restoration and many others.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. The above definitions are provided to clarify their specific use in the context of the invention.

1. A method for re-vegetating soil comprising the steps of:
spreading a water soluble capsule that contains in a water soluble shell at least one type of plant seed and soil over an area of land to be re-vegetated;
the water soluble shell comprising polyvinyl alcohol and dissolving when exposed to a chosen temperature of water for a chosen amount of time; and
once the water soluble shell dissolves, the materials inside releasing to form a mini-environment on the ground to allow for sustained seed growth.

2. The method for re-vegetating soil of claim 1, wherein the water soluble capsule further comprises one or more items selected from the group consisting of:
mulch, bio-char, fertilizer, red mud, and compost.

3. The method for re-vegetating soil of claim 1, wherein the chosen temperature of water is above 45 degrees and the chosen amount of time is less than 10 minutes.

4. A water soluble capsule for re-vegetating soil comprising:
a water soluble shell that becomes water soluble when exposed to a chosen temperature of water for a chosen amount of time, the water soluble shell comprising polyvinyl alcohol;
the water soluble capsule containing at least one type of plant seed and soil.

5. The water soluble capsule of claim 4, wherein the water soluble capsule further comprises one or more items selected from the group consisting of: mulch, soil, bio-char, fertilizer, red mud, and compost.

6. The water soluble capsule of claim 4, wherein the chosen temperature of water is above 45 degrees and the chosen amount of time is less than 10 minutes.
